(19) United States
(12) Patent Application Publication
(10) Pub. No.: US 2025/0330283 A1
(43) Pub. Date: Oct. 23, 2025

(54) POSITIONING METHOD AND DEVICE, AND STORAGE MEDIUM

(71) Applicant: Beijing Xiaomi Mobile Software Co., Ltd., Beijing (CN)

(72) Inventor: Mingju LI, Beijing (CN)

(21) Appl. No.: 18/859,137

(22) PCT Filed: Apr. 27, 2022
(86) PCT No.: PCT/CN2022/089663

§ 371 Date: Oct. 22, 2024

(51) Int. Cl. H04L 5/00; G01S 5/06; H04W 64/00; H04W 72/0446

(52) U.S. Cl. CPC H04L 5/005; G01S 5/06; H04W 64/00; H04W 72/0446

(57) ABSTRACT

A positioning method, the method is used for a terminal device and includes: receiving configuration information of a positioning signal which is sent by a network device, where the positioning signal is configured to obtain a carrier phase difference based on carrier phases at different time points.

### CROSS REFERENCE TO RELATED APPLICATION

The present application is a U.S. National Stage of International Application No. PCT/CN2022/089663, filed on Apr. 27, 2022 the contents of all of which are incorporated herein by reference in their entireties for all purposes.

### BACKGROUND OF THE INVENTION

A network device needs to obtain position information of a terminal device in various position-based services of communications, navigation, positioning and the like.

At present, in a 5G (5th Generation Mobile Networks NR (New Radio) system, a positioning method of carrier phase measurement is adopted, for example, a downlink positioning signal configuration sent by the network device is received by the terminal device, a downlink positioning signal sent by a positioning node is received by the terminal device based on the downlink positioning signal configuration, a carrier phase is measured, a measurement report is reported to the network device, and a position of the terminal device is calculated by the network device.

### SUMMARY OF THE INVENTION

According to an aspect of the disclosure, a positioning method is provided, performed by a terminal device, including:

receiving configuration information of a positioning signal sent by a network device, where the positioning signal is configured to obtain a carrier phase difference based on carrier phases at different time points.

According to an aspect of the disclosure, a positioning method is provided, performed by a positioning node, including:

receiving a positioning signal sent by a terminal device, where the positioning signal is configured to obtain a carrier phase difference based on carrier phases at different time points.

According to an aspect of the disclosure, a positioning method is provided, performed by a network device, including:
sending configuration information of a positioning signal to a terminal device, where the positioning signal is configured to obtain a carrier phase difference based on carrier phases at different time points.

According to an aspect of the disclosure, a terminal device is provided, including: a processor and a transceiver connected with the processor; where
the transceiver is configured to receive configuration information of a positioning signal sent by a network device, where the positioning signal is configured to obtain a carrier phase difference based on carrier phases at different time points.

According to an aspect of the disclosure, a network device is provided, including: a processor and a transceiver connected with the processor; where
the transceiver is configured to receive a positioning signal sent by a terminal device, where the positioning signal is configured to obtain a carrier phase difference based on carrier phases at different time points.

According to an aspect of the disclosure, a network device is provided, including: a processor and a transceiver connected with the processor; where
the transceiver is configured to send configuration information of a positioning signal to a terminal device, where the positioning signal is configured to obtain a carrier phase difference based on carrier phases at different time points.

### BRIEF DESCRIPTION OF DRAWINGS

In order to more clearly describe technical solutions in examples of the disclosure, accompanying drawings needed in the description of the examples will be briefly introduced below. Apparently, the accompanying drawings in the following description are merely some examples of the disclosure, and those ordinarily skilled in the art may also obtain other accompanying drawings according to these accompanying drawings without making creative work.

FIG. 1 is a schematic diagram of a communication system provided by an example of the disclosure.

FIG. 2 is a flowchart of a positioning method provided by an example of the disclosure.

FIG. 3 is a flowchart of a positioning method provided by an example of the disclosure.

FIG. 4 is a flowchart of a positioning method provided by an example of the disclosure.

FIG. 5 is a schematic diagram of a positioning method provided by an example of the disclosure.

FIG. 6 is a flowchart of a positioning method provided by an example of the disclosure.

FIG. 7 is a flowchart of a positioning method provided by an example of the disclosure.

FIG. 8 is a flowchart of a positioning method provided by an example of the disclosure.

FIG. 9 is a flowchart of a positioning method provided by an example of the disclosure.

FIG. 10 is a flowchart of a positioning method provided by an example of the disclosure.

FIG. 11 is a flowchart of a positioning method provided by an example of the disclosure.

FIG. 12 is a structural block diagram of a positioning apparatus provided by an example of the disclosure.

FIG. 13 is a structural block diagram of a positioning apparatus provided by an example of the disclosure.

FIG. 14 is a structural block diagram of a positioning apparatus provided by an example of the disclosure.

FIG. 15 is a schematic structural diagram of a communication device provided by an example of the disclosure.

### DETAILED DESCRIPTION OF THE INVENTION

In order to make objectives, technical solutions and advantages of the disclosure clearer, implementations of the disclosure will be further described in detail below with reference to accompanying drawings. Examples will be described in detail here, and their instances are represented in the accompanying drawings. Unless otherwise indicated, when the following description refers to the accompanying drawings, the same number in the different accompanying drawings represents the same or similar elements. Implementations described in the following examples do not represent all implementations consistent with the disclosure. Rather, they are merely examples of an apparatus and method consistent with some aspects of the disclosure as detailed in the appended claims. A communication system and a service scene described in the examples of the disclosure are intended to describe the technical solution of the examples of the disclosure more clearly but do not constitute a limitation on the technical solution provided by the examples of the disclosure, and those ordinarily skilled in the art may know that with evolution of the communication system and emergence of a new service scene, the technical solution provided by the examples of the disclosure is also applicable to similar technical problems. Terms used in the disclosure are merely intended to describe specific examples but not to limit the disclosure. “A/an”, “the” and “said” in a singular form used in the disclosure and the appended claims are also intended to include a plural form unless other meanings are indicated clearly in the context. It is to be further understood that a term “and/or” used here refers to and contains any one or all possible combinations of one or more associated listed items.

It is to be understood that various pieces of information, possibly described by using terms such as first and second in the disclosure, are supposed not to be limited to these terms. These terms are merely used to distinguish the same type of information. For example, without departing from the scope of the disclosure, a first parameter may also be called a second parameter, and similarly, the second parameter may also be called the first parameter. Depending on the context, words such as “if” and “in a case that” used here may be construed as “when . . . ”, or “while . . . ” or “in response to determining”.

It needs to be noted that information (including but not limited to user equipment information, user personal information and the like), data (including but not limited to data for analysis, data for storage, data for presentation and the like) and signals involved in the disclosure are authorized by a user or authorized fully by various parties, and collection, use and processing of the related data need to conform to related laws, regulations and standards of related countries and regions.

The measured carrier phase includes at least one of the number of whole cycles and a decimal part of an incomplete cycle of the carrier phase, the decimal part of the incomplete cycle may be obtained by making a difference between a phase of a reference signal and a phase of the downlink positioning signal received by the terminal device or obtained by the phase of the downlink positioning signal received by the terminal device. However, the number of whole cycles cannot be obtained by direct measurement by the terminal device and can only be obtained by a fuzzy estimation.

The disclosure relates to the field of wireless communications, in particular to a positioning method and a device, and a storage medium, which may improve positioning accuracy.

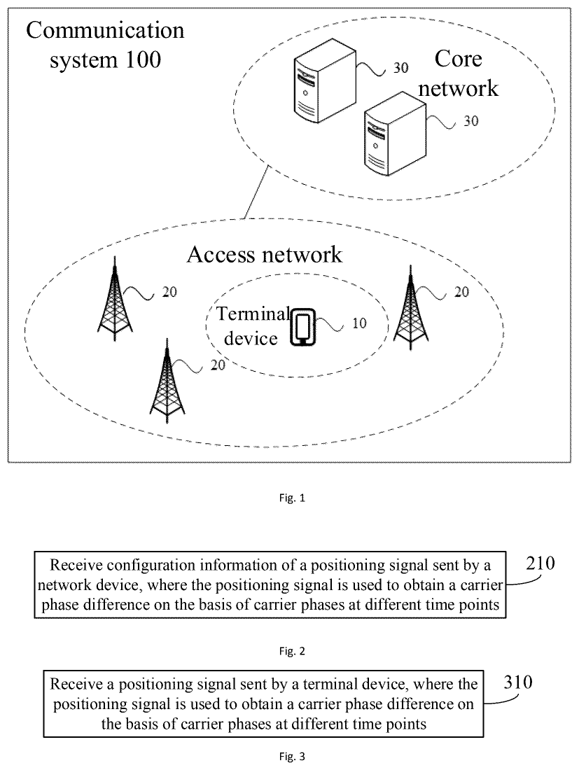

Please refer to FIG. 1, which shows a schematic diagram of a communication system 100 provided by an example of the disclosure. The communication system 100 may include: a terminal device 10 and a network device. The network device may include at least one of an access network device 20 and a core network device 30.

The terminal device 10 may refer to user equipment (UE), an access terminal, a user unit, a user station, a mobile radio station, a mobile station (MS), a remote station, a remote terminal, a mobile device, a wireless communication device, a user agent or a user apparatus. In some examples, the terminal device 10 may also be a cell phone, a cordless telephone, a session initiation protocol (SIP) telephone, a wireless local loop (WLL) station, a personal digital assistant (PDA), a hand-held device with a wireless communication function, a computing device or another processing device connected to a wireless modem, a vehicle-mounted device, a wearable device, a terminal device in a 5th generation system (5GS) or a terminal device in a future evolved public land mobile network (PLMN), etc., which is not limited in the examples of the disclosure. For convenient description, the devices mentioned above are collectively called the terminal device. There are a plurality of terminal devices 10 in general, and one or more terminal devices 10 may be distributed in a cell managed by each access network device 20.

The access network device 20 is a device which is deployed in an access network and configured to provide a wireless communication function for the terminal device 10. The access network device 20 may include various forms of a macro site, a micro site, a relay station, an access point, etc. In a system adopting different wireless access technologies, names of the devices having an access network device function may be different, which is called, for example, gNodeB or gNB in a 5G NR system. With evolution of the communication technology, the name “access network device” may change. For convenient description, in the examples of the disclosure, the apparatuses for providing the wireless communication function for the terminal device 10 are collectively called the access network device. In some examples, a communication relationship may be established between the terminal device 10 and the core network device 30 through the access network device 20. For example, in a long term evolution (LTE) system, the access network device 20 may be one or more eNodeB in an evolved universal terrestrial radio access network (EUTRAN) or EUTRAN. In the 5G NR system, the access network device 20 may be one or more gNB in a radio access network (RAN) or RAN.

For example, each access network device 20 includes one or more transmission reference points (TRPs), and each TRP may be called a positioning node. A downlink positioning signal sent by the positioning node is received by the terminal device, and measured and reported. Alternatively, an uplink positioning signal is sent by the terminal device, and the uplink positioning signal sent by the terminal device is received by the positioning node, and measured and reported.

The core network device 30 is a device deployed in the core network, plays a main role in providing user connection, performing user management and completing service carrying and serves as a bear network to be provided to an interface of an external network. For example, the core network device in the 5G NR system may include an access and mobility management function (AMF) network element, a user plane function (UPF) network element, a session management function (SMF) network element and the like.

For example, the core network device 30 in the example of the disclosure may include a location management function network element. In some examples, the location management function network element includes a location server, the location server may be implemented as any of the following: the location management function (LMF) network element, an enhanced serving mobile location centre (E-SMLC), secure user plane location (SUPL), and an SUPL location platform (SUPL SLP).

In an example, the access network device 20 and the core network device 30 communicate with each other through a certain radio technology, for example, an NG interface in the 5G NR system. In an example, the access network device 20 and the terminal device 10 communicate with each other through a certain radio technology, for example, a Uu interface.

“5G NR system” in the example of the disclosure may also be called a 5G system or NR system, whose meaning may be understood by those skilled in the art. The technical solutions described in the examples of the disclosure may be suitable for the 5G NR system and also suitable for a subsequent evolution system of the 5G NR system.

The technical solution in the example of the disclosure may be applied to various communication systems, for example, a global system of mobile communication (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolution system of the NR system, a LTE (LTE-based access to Unlicensed spectrum, LTE-U) system on an unlicensed frequency band, an NR-U system, a universal mobile telecommunication system (UMTS), a worldwide interoperability for microwave access (WiMAX) communication system, a wireless local area networks (WLAN), a wireless fidelity (WiFi), a next generation communication system or another communication system, etc.

Please refer to FIG. 2, which shows a flowchart of a positioning method provided by an example of the disclosure. The method may be applied to a terminal device. The terminal device may be a terminal device in the communication system shown in FIG. 1. The method includes step 210.

In step 210: configuration information of a positioning signal sent by a network device is received, where the positioning signal is configured to obtain a carrier phase difference based on carrier phases at different time points.

The positioning signal is configured to obtain the carrier phase difference. The carrier phase difference is a difference value between carrier phases measured at different time points for the positioning signal. For example, the carrier phase difference is a difference value between carrier phases measured at different time points for the same positioning signal when the terminal device is located in different positions, namely, the terminal device needs to have a displacement within a time interval corresponding to the carrier phase difference. It needs to be noted that “the same positioning signal” here may be a positioning signal sent at the same sending time point or a positioning signal sent at different time points. For example, the positioning signal #1 is a positioning signal sent periodically, the positioning signal sent at the same sending time point means that the positioning signal #1 is sent at the sending time point within one cycle and measured by a terminal at different time points; and the positioning signal sent at different time points means a positioning signal #1 sent in an i^{th} cycle and a positioning signal #1 sent in an j^{th} cycle, the positioning signal #1 sent in the i^{th} cycle is measured by the terminal at the first time point, and the positioning signal #1 sent in the j^{th} cycle is measured by the terminal at the second time point.

In a downlink positioning scene, the carrier phase difference includes: a difference value between carrier phases measured by the terminal device at different time points for the positioning signal sent by a positioning node.

In an uplink positioning scene, the carrier phase difference includes: a difference value between carrier phases measured by the positioning node at different time points for the positioning signal sent by the terminal device.

The carrier phase difference is a difference value between carrier phases at two time points for the same positioning signal. The same positioning signal refers to a positioning signal sent continuously within a time interval. For example, in the downlink positioning scene, a first positioning signal is continuously sent by the positioning node within a first time interval, the first positioning signal is measured by the terminal device respectively at the first time point and the second time point within the first time interval, so corresponding carrier phases of the first positioning signal at the two time points are obtained respectively, and thus a carrier phase difference corresponding to the two time points is obtained. For another example, in the uplink positioning scene, a second positioning signal is continuously sent by the terminal device within a second time interval, the second positioning signal is measured by the positioning node respectively at the third time point and the fourth time point within the second time interval, so corresponding carrier phases of the second positioning signal at the two time points are obtained respectively, and thus a carrier phase difference corresponding to the two time points is obtained.

For example, when the positioning signal is configured to be the positioning signal sent periodically, the same positioning signal refers to the positioning signal sent at different time points, and the different time points may be different time points within the same cycle or different time points within different cycles. For example, for the positioning signal #1 sent in the i^{th} cycle and the positioning signal #1 sent in the j^{th} cycle, the positioning signal #1 sent in the i^{th} cycle is measured by the terminal device/positioning node at the first time point, and the positioning signal #1 sent in the j^{th} cycle is measured by the terminal device/positioning node at the second time point. For another example, for the positioning signal #1 sent in the i^{th} cycle, the positioning signal #1 sent in the i^{th} cycle is measured by the terminal device/positioning node at the first time point and the second time point respectively.

The carrier phase difference may also be a difference value between carrier phases at two time points for different positioning signals. The different positioning signals may be sent at the same time or sent at different time. The different positioning signals are sent by the same terminal device/positioning node. For example, in the downlink positioning scene, the positioning node sends the first positioning signal within the time interval A and sends the second positioning signal within the time interval B, and the time interval A and the time interval B may be the same or not (being not the same means that at least one of start time or end time is different). A first carrier phase is obtained by measuring the first positioning signal by the terminal device at time point A within the time interval A, a second carrier phase is obtained by measuring the second positioning signal by the terminal device at time point B within the time interval B, the carrier phase difference is a difference value between the first carrier phase and the second carrier phase, and the two time points, namely, the time point A and the time point B for measuring the positioning signals are different. For another example, in the uplink positioning scene, the terminal device sends a third positioning signal within a time interval C and sends a fourth positioning signal within a time interval D, and the time interval C and the time interval D may be the same or not (being not the same means that at least one of start time or end time is different). A third carrier phase is obtained by measuring the third positioning signal by the positioning node at time point C within the time interval C, a fourth carrier phase is obtained by measuring the fourth positioning signal by the positioning node at time point D within the time interval D, the carrier phase difference is a difference value between the third carrier phase and the fourth carrier phase, and the two time points, namely, the time point C and the time point D for measuring the positioning signals are different.

The different positioning signals may also be sent by different terminal devices/positioning nodes. For example, in the downlink positioning scene, a positioning node #1 sends the first positioning signal within the time interval A, a positioning node #2 sends the second positioning signal within the time interval B, and the time interval A and the time interval B may be the same or not (being not the same means that at least one of start time or end time is different). The first carrier phase is obtained by measuring the first positioning signal by the terminal device at the time point A within the time interval A, the second carrier phase is obtained by measuring the second positioning signal by the terminal device at the time point B within the time interval B, the carrier phase difference is a difference value between the first carrier phase and the second carrier phase, and the two time points, namely, the time point A and the time point B for measuring the positioning signals are different. For another example, in the uplink positioning scene, a terminal device #1 sends the third positioning signal within the time interval C, a terminal device #2 sends the fourth positioning signal within the time interval D, and the time interval C and the time interval D may be the same or not (being not the same means that at least one of start time or end time is different). The third carrier phase is obtained by measuring the third positioning signal by the positioning node at the time point C within the time interval C, the fourth carrier phase is obtained by measuring the fourth positioning signal by the positioning node at the time point D within the time interval D, the carrier phase difference is a difference value between the third carrier phase and the fourth carrier phase, and the two time points, namely, the time point C and the time point D for measuring the positioning signals are different.

The positioning node is a TRP, in some examples, the positioning node is a TRP of an access network device, or the positioning node is a positioning component/positioning function module on the access network device. The positioning node may be a TRP of a serving cell of the terminal device, or the positioning node may also be a TRP of a neighbor cell of the terminal device.

The network device in the example of the disclosure refers to: the access network device or a core network device. When the network device is the access network device, the access network device is an access network device of the serving cell of the terminal device.

A carrier phase difference corresponds to a positioning node and a terminal device, namely, the method provided by the example of the disclosure is that the carrier phase difference is obtained by measuring the positioning signal between the terminal device and the positioning node. In an implementation, there is a case that a carrier phase difference corresponds to two positioning nodes and a terminal device, namely, during downlink positioning, the terminal device may receive the positioning signals sent respectively by the two positioning nodes, and the two positioning signals are measured respectively at different time point so as to obtain the carrier phase difference.

The carrier phase difference may also be called a relative carrier phase. The carrier phase difference is defined as a difference value between carrier phases of the positioning signal at two time points. The carrier phase difference may also be understood as a variation value of carrier phases within a period of time between start time point and end time point when the terminal device/positioning node receives the positioning signal.

In the downlink positioning scene, the carrier phase difference is defined as a difference value between carrier phases of the positioning signal obtained by the terminal device in a first time position and a second time position. The first time position includes the first time point and a first position where the terminal device is located at the first time point, and the second time position includes the second time point and a second position where the terminal device is located at the second time point.

The first time point and the second time point are located within the sending time interval of the positioning signal, for example, the positioning signal is sent by the positioning node within the first time interval, so the first time point and the second time point are located within the first time interval. For another example, the positioning signal is sent periodically, and the positioning signal is sent by the positioning node in the first cycle and the second cycle, so the first time point may be located within the first cycle, and the second time point may be located within the second cycle.

Alternatively, the first time point and the second time point are respectively located within the sending time intervals of the different positioning signals, for example, the positioning node sends the first positioning signal within the first time interval and sends the second positioning signal within the second time interval. Thus, the first time point is located within the first time interval, and the second time point is located within the second time interval. The first time interval and the second time interval may be the same time interval or different time intervals (at least one of start time or end time of the time intervals is different), and the first time point is different from the second time point.

The first time position is different from the second time position, namely, the first time point is different from the second time point, and the first position is different from the second position.

In the uplink positioning scene, the carrier phase difference is defined as a difference value between carrier phases of the positioning signal obtained by the positioning node at the third time point and the fourth time point. A position of the terminal device moves from the third time point to the fourth time point, for example, the terminal device is located in a third position at the third time point and located in a fourth position at the fourth time point, the third time point is different from the fourth time point, and the third position is different from the fourth position.

The third time point and the fourth time point are located within the sending time interval of the positioning signal, for example, the positioning signal is sent by the terminal device within a third time interval, so the third time point and the fourth time point are located within the third time interval. For another example, the positioning signal is sent periodically, and the positioning signal is sent by the terminal device in the third cycle and the fourth cycle, so the third time point may be located within the third cycle, and the fourth time point may be located within the fourth cycle.

Alternatively, the third time point and the fourth time point are respectively located within the sending time intervals of the different positioning signals, for example, the terminal device sends the third positioning signal within the third time interval and sends the fourth positioning signal within the fourth time interval. Thus, the third time point is located within the third time interval, and the fourth time point is located within the fourth time interval. The third time interval and the fourth time interval may be the same time interval or different time intervals (at least one of start time or end time of the time intervals is different), and the third time point is different from the fourth time point.

The carrier phase difference includes at least one of the following: the number of whole cycles or a decimal part of an incomplete cycle. A phase of one cycle is 2 pi (2π), and a corresponding distance is a carrier wavelength (λ).

In the downlink positioning scene, the positioning signal is sent by the positioning node according to the configuration information of the positioning signal. The carrier phase difference is obtained by receiving and measuring the positioning signal by the terminal device according to the configuration information of the positioning signal. The positioning signal (the first positioning signal) sent by the positioning node is received by the terminal device in the first time position so as to obtain the first carrier phase; the positioning signal (the second positioning signal) sent by the positioning node is received by the terminal device in the second time position so as to obtain the second carrier phase; and the carrier phase difference includes the difference value between the first carrier phase and the second carrier phase. The first time position is different from the second time position; and the first positioning signal and the second positioning signal may be the same positioning signal or different positioning signals.

The first carrier phase includes at least one of the first number of whole cycles or a first decimal part of an incomplete cycle, and the second carrier phase includes at least one of the second number of whole cycles or a second decimal part of an incomplete cycle. A carrier phase difference obtained by making a difference between the first carrier phase and the second carrier phase includes at least one of the third number of whole cycles or a third decimal part of an incomplete cycle.

In the uplink positioning scene, the positioning signal is sent by the terminal device based on the configuration information of the positioning signal. The carrier phase difference is obtained by receiving and measuring the positioning signal by the positioning node according to the configuration information of the positioning signal. The positioning signal (the third positioning signal) sent by the terminal device is received by the positioning node at the third time point so as to obtain the third carrier phase; the positioning signal (the fourth positioning signal) sent by the terminal device is received by the positioning node at the fourth time point so as to obtain the fourth carrier phase; and the carrier phase difference includes the difference value between the third carrier phase and the fourth carrier phase. The third time point is different from the fourth time point; and the third positioning signal and the fourth positioning signal may be the same positioning signal or different positioning signals.

The third carrier phase includes at least one of the fourth number of whole cycles or a fourth decimal part of an incomplete cycle, and the fourth carrier phase includes at least one of the fifth number of whole cycles or a fifth decimal part of an incomplete cycle. A carrier phase difference obtained by making a difference between the third carrier phase and the fourth carrier phase includes at least one of the sixth number of whole cycles or a sixth decimal part of an incomplete cycle.

The network device may be the access network device or the core network device. For example, when the network device is the core network device, the core network device includes a location management function network element. In some examples, the location management function network element includes a location server. After the location server establishes a radio resource control (RRC) connection to a terminal, the configuration information of the positioning signal is sent to the terminal device by using an LTE positioning protocol (LPP) through an interface between the location server and the terminal device.

The positioning signal sent by the positioning node is received and measured by the terminal device based on the configuration information of the positioning signal so as to obtain the carrier phase difference, the carrier phase difference is used as a measurement result to be reported to the network device, and the network device calculates a position of the terminal device based on the carrier phase difference.

Alternatively, the positioning signal is sent to the positioning node by the terminal device based on the configuration information of the positioning signal. The carrier phase difference is measured by receiving the positioning signal by the positioning node, the carrier phase difference is used as the measurement result to be reported to the network device, and the network device calculates the position of the terminal device based on the carrier phase difference.

For example, the positioning signal includes at least one of the following: a positioning reference signal (PRS), a sounding reference signal (SRS) or a new reference signal for positioning.

In the downlink positioning scene, the positioning signal includes: the PRS or the new reference signal for positioning.

In the uplink positioning scene, the positioning signal includes: the SRS or the new reference signal for positioning.

To sum up, according to the method provided by the present example, for the same positioning signal, the carrier phase difference is obtained by measurement at different time points, and the terminal device is positioned based on the carrier phase difference. The positioning method based on the carrier phase difference is introduced into a cellular network, a positioning signal for carrier phase difference positioning is configured for the terminal device, and the terminal device is caused to receive or send the positioning signal based on the configuration information. The carrier phase difference is measured by the positioning node or the terminal device, the carrier phase difference is reported to the network device, a position of the terminal device is solved by the network device based on the carrier phase difference so as to accurately position the terminal device, and thus the positioning accuracy reaches a centimeter level.

Please refer to FIG. 3, which shows a flowchart of a positioning method provided by an example of the disclosure. The method may be applied to a positioning node. The positioning node may be a TRP in the communication system shown in FIG. 1. The method includes step 310.

In step 310: a positioning signal sent by a terminal device is received, where the positioning signal is configured to obtain a carrier phase difference based on carrier phases at different time points.

In the uplink positioning scene, the positioning signal is sent by the terminal device based on the configuration information of the positioning signal, and the positioning node receives the positioning signal sent by the terminal device and measures the positioning signal so as to obtain the carrier phase difference.

The carrier phase difference includes: a difference value between carrier phases of the positioning signal at two time points. The carrier phase difference includes at least one of the number of whole cycles or a decimal part of an incomplete cycle of the carrier phase difference.

A positioning signal sent by the terminal device is received by the positioning node at the third time point so as to obtain a third carrier phase; a positioning signal sent by the terminal device is received by the positioning node at the fourth time point so as to obtain a fourth carrier phase; and the carrier phase difference includes a difference value between the third carrier phase and the fourth carrier phase.

To sum up, according to the method provided by the present example, for the positioning signal, the carrier phase difference is obtained by measurement at different time points, and the terminal device is positioned based on the carrier phase difference. The positioning method based on the carrier phase difference is introduced into a cellular network, a positioning signal for carrier phase difference positioning is configured for the terminal device, and the terminal device is caused to receive or send the positioning signal based on the configuration information. The carrier phase difference is measured by the positioning node or the terminal device, the carrier phase difference is reported to a network device, a position of the terminal device is solved by the network device based on the carrier phase difference so as to accurately position the terminal device, and thus the positioning accuracy reaches a centimeter level.

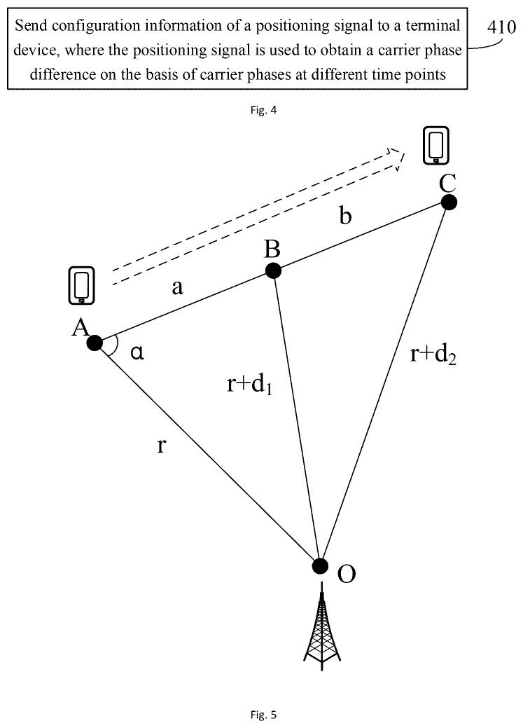

Please refer to FIG. 4, which shows a flowchart of a positioning method provided by an example of the disclosure. The method may be applied to a network device. The network device may be an access network device or a core network device in the communication system shown in FIG. 1. The method includes step 410.

In step 410: configuration information of a positioning signal is sent to a terminal device, where the positioning signal is configured to obtain a carrier phase difference based on carrier phases at different time points.

The configuration information of the positioning signal is used to configure a positioning signal or is used to configure a plurality of positioning signals. For example, the configuration information of the positioning signal is used to indicate to send a positioning signal within a designated time interval. Alternatively, the configuration information of the positioning signal is used to indicate to send a positioning signal periodically according to designated cycles. Alternatively, the configuration information of the positioning signal is used to indicate to send at least two positioning signals at the same time point/different time points.

In a case that the positioning signal is a downlink positioning signal, the configuration information of the positioning signal sent to the terminal device by the network device includes at least one of the following: a cycle, a slotoffset, the number of repetitions in a single cycle, a time interval between two repetitions (a time interval between every two times of repeated sending), the number of occupied symbols, a silent mode, a comb-shaped structure/comb size (comb-size), a position of a start symbol, a sub-carrier space (SCS), quasi-colocation (QCL) information, the number of measured samples, a carrier frequency, a bandwidth or a position of a starting physical resource block (PRB).

For example, the configuration information of the positioning signal further includes: a positioning signal set or a positioning node (positioning node or TRP) corresponding to each positioning signal.

For example, the configuration information of the positioning signal includes: identity information corresponding to the positioning signal, and the identity information includes a positioning signal set identity, or a positioning node identity. In an implementation, the positioning signal may be subjected to set partitioning, for example, positioning signals from the same base station or TRP belong to the same positioning signal set.

In a case that the positioning signal is an uplink positioning signal, the configuration information of the positioning signal sent to the terminal device by the network device includes at least one of the following: a cycle, a slotoffset, the number of occupied symbols, a comb-shaped structure/comb size (comb-size), a position of a start symbol, a sub-carrier space (SCS), quasi-colocation (QCL) information, a carrier frequency, a bandwidth, a position of a starting physical resource block (PRB), power control parameters P0 and alpha, or a pathlossReferenceRS.

For example, the positioning signal is sent periodically or aperiodically or semi-persistent mode. The positioning signal is measured by the terminal device/positioning node at at least two time points within a continuous sending time interval of the positioning signal to obtain the carrier phase difference. Alternatively, the same positioning signal sent periodically is measured by the terminal device/positioning node at different time points to obtain the carrier phase difference. Alternatively, different positioning signals are measured by the terminal device/positioning node at different time points to obtain the carrier phase difference.

To sum up, according to the method provided by the present example, for the positioning signal, the carrier phase difference is obtained by measurement at different time points, and the terminal device is positioned based on the carrier phase difference. The positioning method based on the carrier phase difference is introduced into a cellular network, a positioning signal for carrier phase difference positioning is configured for the terminal device, and the terminal device is caused to receive or send the positioning signal based on the configuration information. The carrier phase difference is measured by the positioning node or the terminal device, the carrier phase difference is reported to the network device, a position of the terminal device is solved by the network device based on the carrier phase difference so as to accurately position the terminal device, and thus the positioning accuracy reaches a centimeter level.

Taking the downlink positioning scene as an example, a method for positioning the terminal device based on the carrier phase difference provided by the example of the disclosure is given.

Please refer to FIG. 5, which shows a schematic diagram of a positioning method provided by an example of the disclosure.

As shown in FIG. 5, the positioning node is located at a point O, and the terminal device moves from a point A to a point C by passing through a point B. A distance AB is a, a distance BC is b, a distance OA is r, a distance OB is r+d₁, and a distance OC is r+d₂. A formula (1-1) may be obtained:

$$\{ \begin{matrix}r = N λ + {φ}_{A} λ \\ r + {d}_{1} = N λ + {φ}_{B} λ \\ r + {d}_{2} = N λ + {φ}_{C} λ\end{matrix} \qquad ( 1 - 1 )$$

where N is the number of whole cycles of carrier phases of the positioning signal which cannot be measured by the terminal device at the point A, φ_{A} is a decimal part of a carrier phase of a positioning signal which is measured by the terminal device at the point A, φ_{B} is φ_{A} plus a variation value of carrier phases of the positioning signal in time corresponding to the point A and the point B, φ_{C} is φ_{A} plus a variation value of carrier phases of the positioning signal in time corresponding to the point A and the point C, and λ is a carrier wavelength of the positioning signal.

According to a geometrical relationship in FIG. 5, a formula (1-2) may be obtained:

$$\{ \begin{matrix}{( r + {d}_{1} )}^{2} = {r}^{2} + {a}^{2} - 2 arcos α \\ {( r + {d}_{2} )}^{2} = {r}^{2} + {( a + b )}^{2} - 2 ( a + b ) r cos α\end{matrix} \qquad ( 1 - 2 )$$

A formula (1-3) may be obtained by performing simultaneous solving and elimination on two equations in the formula (1-2):

$$r = \frac{( a + b ) ( {a}^{2} - {d}_{1}^{2} ) - a [ {( a + b )}^{2} - {d}_{2}^{2} ]}{2 [ ( a + b ) {d}_{1} - 2 a {d}_{2} ]} \qquad ( 1 - 3 )$$

where d₁=(φ_{B}−φ_{A})λ and d₂=(φ_{C}−φ_{A})λ are substituted into the formula (1-3) and the formula (1-1) so as to obtain an expression formula (1-4) of ambiguity of the whole cycles:

$$N = \frac{\{ \frac{( a + b ) ( {a}^{2} - {( {φ}_{B} - {φ}_{A} )}^{2} ) - a [ {( a + b )}^{2} - {( {φ}_{C} - {φ}_{A} )}^{2} ]}{2 [ ( a + b ) ( {φ}_{B} - {φ}_{A} ) - 2 a ( {φ}_{C} - {φ}_{A} ) ]} - {φ}_{A} \}}{λ} \qquad ( 1 - 4 )$$

where (φ_{B}−φ_{A}) or (φ_{C}−φ_{A}) is the carrier phase difference in the example of the disclosure. Thus, the ambiguity of the whole cycles may be calculated according to the carrier phase difference, a distance between different positions where the terminal device is located during measurement of the carrier phases and the carrier wavelength, and thus a distance r between the terminal device and the positioning node is calculated according to the formula (1-1). The position of the terminal device may be obtained by obtaining the distance r between the terminal device and a plurality of positioning nodes.

An example of obtaining the carrier phase difference by measuring the downlink positioning signal by the terminal device in the downlink positioning scene is given.

Please refer to FIG. 6, which shows a flowchart of a positioning method provided by an example of the disclosure. The method may be applied to a terminal device, a TRP (positioning node) and a network device in the communication system shown in FIG. 1. The network device may be an access network device or a core network device. The method includes steps 501-503.

In step 501: configuration information of a positioning signal sent by the network device is received by the terminal device.

For example, an LPP message is sent to the terminal device by the network device. The LPP message includes the configuration information of the positioning signal. The LPP message sent by the network device is received by the terminal device, and the configuration information of the positioning signal in the LPP message is read by the terminal device. The configuration information is used to configure the positioning signal so the terminal device is caused to receive the positioning signal based on the configuration information of the positioning signal.

The positioning signal is a downlink positioning signal, for example, the positioning signal may be a PRS or another downlink positioning signal.

In step 502: a positioning signal sent by the positioning node is received by the terminal device.

The positioning signal is sent by the positioning node based on the configuration information of the positioning signal. The positioning signal is received by the terminal device based on the configuration information of the positioning signal and measured at at least two time points to obtain the carrier phase difference.

For example, the positioning signal is received by the terminal device based on the configuration information of the positioning signal and measured respectively in a first time position and a second time position so as to obtain the carrier phase difference.

The carrier phase difference corresponds to two timestamps of two time points, or the carrier phase difference corresponds to a time interval between two time points. The carrier phase difference further corresponds to an identity of at least one positioning signal, an identity of the terminal device and an identity of the positioning node.

For example, when the carrier phase difference is obtained by measuring the same positioning signal by the terminal device at different time points, the carrier phase difference corresponds to an identity of a positioning signal. When the carrier phase difference is obtained by measuring different positioning signals by the terminal device at different time points, the carrier phase difference corresponds to identities of at least two positioning signals.

For example, the carrier phase difference corresponds to a timestamp of first time point and a timestamp of second time point; or the carrier phase difference corresponds to a time interval from the first time point to the second time point.

The carrier phase difference corresponds to a moving distance of the terminal device between the two time points, or the carrier phase difference corresponds to a speed (for example, an average speed) of the terminal device between the two time points, or the carrier phase difference corresponds to a moving speed of the terminal device within a time interval between the two time points, or the carrier phase difference corresponds to a moving distance of the terminal device within the time interval between the two time points.

For example, the carrier phase difference corresponds to a first distance for which the terminal device moves from the first time point to the second time point. Alternatively, the carrier phase difference corresponds to an average speed of the terminal device from the first time point to the second time point. Alternatively, the carrier phase difference corresponds to a first distance for which the terminal device moves within a first time interval (from the first time point to the second time point). Alternatively, the carrier phase difference corresponds to an average speed at which the terminal device moves within the first time interval (from the first time point to the second time point).

For example, a moving distance/moving speed of the terminal device within a period of time may be obtained by an inertial navigation system (INS) in the terminal device. The position, the moving speed, the moving distance and other information of the terminal device are calculated by the INS by using an inertial sensor (such as a gyroscope and an accelerometer) according to a reference direction and original position information.

For example, the gyroscope and the accelerometer are two most important inertial sensors in the inertial navigation system, in the INS, there are three gyroscopes and three accelerometers in general which are respectively mounted on three shafts perpendicular to one another, and each shaft is provided with a gyroscope and an accelerometer. Each shaft of the three shafts points to a direction to measure a rotation angular velocity and a motion acceleration in this direction. After data of the gyroscope and the accelerometer is obtained by the INS, six degree-of-freedom variables of the terminal device in a space may be determined through integration, namely, three space position coordinate components and three running attitude angles. The running attitude angles usually include a yaw, a pinch and a roll.

For example, a plurality of carrier phase differences of one positioning signal may be measured by the terminal device. For example, the terminal device may measure a first positioning signal at T1 and T2 to obtain a first carrier phase difference and measures the first positioning signal at T3 and T4 to obtain a second carrier phase difference. T denotes time point, T1 and T3 may be the same, and T2 is different from T4; or T1 is different from T3, and T2 and T4 are the same; or T1 is different from T3, T2 is different from T4, and T2 and T3 may be the same or not.

For example, a plurality of carrier phase differences of two different positioning signals may be measured by the terminal device. For example, the terminal device may measure the first positioning signal at T1 and a second positioning signal at T2 to obtain the first carrier phase difference, and measure a third positioning signal at T3 and a fourth positioning signal at T4 to obtain the second carrier phase difference. T1 is different from T2, T3 is different from T4, T1 and T3 may be the same or not, and T2 and T4 may be the same or not. The first positioning signal and the second positioning signal are sent by the same positioning node, for example, a first positioning node. The third positioning signal and the fourth positioning signal are sent by the same positioning node, for example, a second positioning node. The first positioning node and the second positioning node are the same positioning node or different positioning nodes.

For example, a plurality of positioning signals sent by a plurality of positioning nodes may be measured simultaneously by the terminal device so as to obtain at least one carrier phase difference corresponding to each positioning signal. For example, in step 502a and step 502b shown in FIG. 7, the terminal device may receive the first positioning signal sent by the first positioning node and receive the second positioning signal sent by the second positioning node. The first carrier phase difference is obtained by measuring the first positioning signal at t1 and t2, and the second carrier phase difference is obtained by measuring the second positioning signal at t3 and t4. t1 may be the same as t3 and t4 or not, t2 may be the same as t3 and t4 or not, t1 is different from t2, and t3 is different from t4.

In step 503: the carrier phase difference is obtained by the terminal device.

The carrier phase difference is a measurement result of the terminal device. The carrier phase difference is a measurement result obtained by measuring the positioning signal by the terminal device in two time positions. For example, the terminal device performs measurement in a first time position to obtain a first carrier phase and performs measurement in a second time position to obtain a second carrier phase, and the carrier phase difference is obtained by calculating a difference between the first carrier phase and the second carrier phase. Alternatively, the carrier phase difference is obtained by measuring a phase variation value of the positioning signal by the terminal device from the first time position to the second time position.

In an example, at least one obtained carrier phase difference may be sent to the network device by the terminal device. In an example, the terminal device may calculate the position of the terminal device based on the at least one carrier phase difference to obtain position information, and the position information of the terminal device is sent to the network device by the terminal device.

To sum up, according to the method provided by the present example, the same positioning signal sent by the positioning node is measured by the terminal device in a plurality of time positions to obtain the carrier phase difference, and the position of the terminal device is solved based on the carrier phase difference. The terminal device may be positioned accurately by the method, so that the positioning accuracy reaches a centimeter level.

An example of reporting a downlink positioning report by the terminal device in the downlink positioning scene is given.

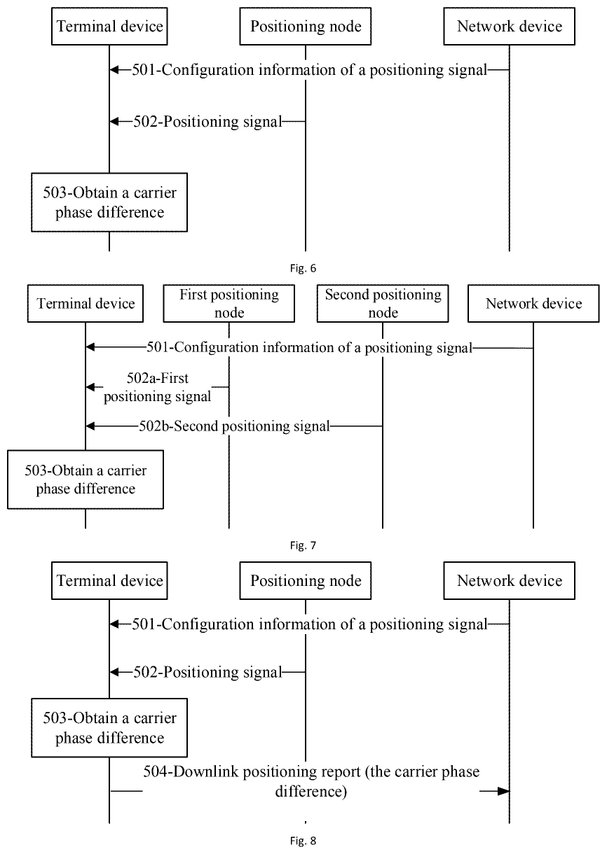

Please refer to FIG. 8, which shows a flowchart of a positioning method provided by an example of the disclosure. The method may be applied to a terminal device, a TRP (positioning node) and a network device in the communication system shown in FIG. 1. The network device may be an access network device or a core network device. Based on the example shown in FIG. 6, the method further includes step 504.

In step 501: configuration information of a positioning signal sent by the network device is received by the terminal device.

For example, the configuration information indicates that there are three positioning nodes to send the positioning signal.

In step 502: a positioning signal sent by the positioning node is received by the terminal device.

For example, the terminal device receives a first positioning signal sent by a first positioning node, receives a second positioning signal sent by a second positioning node, receives a third positioning signal sent by a third positioning node, receives a fourth positioning signal sent by a fourth positioning node and receives a fifth positioning signal sent by a fifth positioning node. The carrier phase differences corresponding to each positioning signal at different time points or a carrier phase difference corresponding to every two positioning signals is measured on each positioning signal.

In step 503: the carrier phase difference is obtained by the terminal device.

For example, the first positioning signal sent by the first positioning node is measured by the terminal device at a moment 1 and a moment 2 to obtain a first carrier phase difference and at a moment 3 and a moment 4 to obtain a second carrier phase difference. Related information of the first carrier phase difference is recorded, for example, including at least one of the following: the first carrier phase difference, a timestamp of the moment 1, a timestamp of the moment 2, a time interval from the moment 1 to the moment 2, a moving distance of the terminal device from the moment 1 to the moment 2, a moving speed of the terminal device from the moment 1 to the moment 2, an identity of the first positioning node or an identity of the first positioning signal. Related information of the second carrier phase difference is recorded, for example, including at least one of the following: the second carrier phase difference, a timestamp of the moment 3, a timestamp of the moment 4, a time interval from the moment 3 to the moment 4, a moving distance of the terminal device from the moment 3 to the moment 4, a moving speed of the terminal device from the moment 3 to the moment 4, an identity of the first positioning node or an identity of the first positioning signal.

The second positioning signal sent by the second positioning node is measured by the terminal device within a first time interval to obtain a third carrier phase difference and within a second time interval to obtain a fourth carrier phase difference. Related information of the third carrier phase difference is recorded, for example, including at least one of the following: the third carrier phase difference, a timestamp of start time of the first time interval, a timestamp of end time of the first time interval, the first time interval, a moving distance of the terminal device within the first time interval, a moving speed of the terminal device within the first time interval, an identity of the second positioning node or an identity of the second positioning signal. Related information of the fourth carrier phase difference is recorded, for example, including at least one of the following: the fourth carrier phase difference, a timestamp of start time of the second time interval, a timestamp of end time of the second time interval, the second time interval, a moving distance of the terminal device within the second time interval, a moving speed of the terminal device within the second time interval, an identity of the second positioning node or an identity of the second positioning signal.

The third positioning signal sent by the third positioning node is measured by the terminal device at the moment 1 and the moment 2 to obtain a fifth carrier phase difference and at the moment 3 and the moment 4 to obtain a sixth carrier phase difference. Related information of the fifth carrier phase difference is recorded, for example, including at least one of the following: the fifth carrier phase difference, the timestamp of the moment 1, the timestamp of the moment 2, the time interval from the moment 1 to the moment 2, the moving distance of the terminal device from the moment 1 to the moment 2, the moving speed of the terminal device from the moment 1 to the moment 2, an identity of the third positioning node or an identity of the third positioning signal. Related information of the sixth carrier phase difference is recorded, for example, including at least one of the following: the sixth carrier phase difference, a timestamp of the moment 3, a timestamp of the moment 4, a time interval from the moment 3 to the moment 4, a moving distance of the terminal device from the moment 3 to the moment 4, a moving speed of the terminal device from the moment 3 to the moment 4, an identity of the third positioning node or an identity of the third positioning signal.

The terminal device measures the fourth positioning signal sent by the fourth positioning node and the fifth positioning signal sent by the fifth positioning node, measures the fourth positioning signal at the moment 1 and measures the fifth positioning signal at the moment 2 to obtain a seventh carrier phase difference. Related information of the seventh carrier phase difference is recorded, for example, including at least one of the following: the seventh carrier phase difference, the timestamp of the moment 1, the timestamp of the moment 2, the time interval from the moment 1 to the moment 2, the moving distance of the terminal device from the moment 1 to the moment 2, the moving speed of the terminal device from the moment 1 to the moment 2, an identity of the fourth positioning node, an identity of the fourth positioning signal, an identity of the fifth positioning node or an identity of the fifth positioning signal. The fourth positioning node and the fifth positioning node are the same positioning node or different positioning nodes.

In step 504: a downlink positioning report is sent to the network device by the terminal device, where the downlink positioning report includes the carrier phase difference.

The network device receives the downlink positioning report and performs a calculation based on the downlink positioning report to obtain a position of the terminal device.

The downlink positioning report includes at least one of the following: the carrier phase difference, two timestamps corresponding to the carrier phase difference, the time interval between two time points corresponding to the carrier phase difference, a moving distance of the terminal device within a time interval between the two timestamps or between the two time points, a moving speed of the terminal device within the time interval between the two timestamps or between the two time points, phase error group information corresponding to the carrier phase difference, a positioning node (an identity of the positioning node) corresponding to the carrier phase difference, a positioning signal identity (an identity of a positioning signal) corresponding to the carrier phase difference, an identity of a positioning signal set corresponding to the carrier phase difference and collineation path indication information corresponding to the carrier phase difference.

The phase error group information includes a phase error group ID or an error value or a time error group ID. The positioning node corresponding to the carrier phase difference includes at least one positioning node. The positioning signal identity corresponding to the carrier phase difference includes at least one positioning signal identity.

One carrier phase difference corresponds to two timestamps, two timestamps corresponding to different carrier phase differences of the different positioning signals may be the same or not, and two timestamps corresponding to different carrier phase differences of the same positioning signal may not be completely the same.

The collineation path indication information is used to indicate whether a path measurement result is a collineation path or indicate a probability of the collineation path.

A positioning report further includes at least one of the following: reference signal receiving power (RSRP), an angle of arrival (AoA), an angle of departure (AoD), time of arrival (ToA), a time difference of arrival (TDoA), round trip time (RTT) or a timing error group. The timing error group includes an Rx timing error group (REG) or a Tx Rx timing error group (TREG).

For example, a parameter in the positioning report may be based on a measurement result of a path, namely, different paths correspond to a group of parameters in the above positioning report respectively. Alternatively, the different paths may not be considered in the positioning report, namely, the different paths correspond to the same group of parameters in the above positioning report.

For example, the terminal device may report a positioning report of measurement this time to the network device when a time window for measuring the positioning signal is over, where at least one carrier phase difference is included in the positioning report. The terminal device may also report the positioning report to the network device after obtaining a carrier phase difference, where the positioning report includes a carrier phase difference and related information of the same.

To sum up, according to the method provided by the present example, the positioning report may be reported to the network device by the terminal device, the positioning report includes the carrier phase difference, the position of the terminal device is solved by the network device based on the carrier phase difference, the terminal device may be positioned accurately, and the positioning accuracy reaches a centimeter level.

An example of obtaining the carrier phase difference by measuring the uplink positioning signal by the positioning node in the uplink positioning scene is given.

Please refer to FIG. 9, which shows a flowchart of a positioning method provided by an example of the disclosure. The method may be applied to a terminal device, a TRP (positioning node) and a network device in the communication system shown in FIG. 1. The network device may be an access network device or a core network device. The method includes steps 601-603.

In step 601: configuration information of a positioning signal sent by the network device is received by the terminal device.

For example, an LPP message is sent to the terminal device by the network device. The LPP message includes the configuration information of the positioning signal. The LPP message sent by the network device is received by the terminal device, and the configuration information of the positioning signal in the LPP message is read by the terminal device. The configuration information is used to configure the positioning signal so the terminal device is caused to send the positioning signal based on the configuration information.

The positioning signal is an uplink positioning signal, for example, the positioning signal may be an SRS or another uplink positioning signal.

In step 602: a positioning signal sent by the terminal device is received by the positioning node.

The positioning signal is sent by the terminal device based on the configuration information of the positioning signal. The positioning signal is received by the positioning node based on the configuration information of the positioning signal and measured at at least two time points to obtain the carrier phase difference.

For example, the positioning signal is received by the positioning node based on the configuration information of the positioning signal and measured respectively at third time point and fourth time point so as to obtain the carrier phase difference.

The carrier phase difference corresponds to two timestamps of two time points, or the carrier phase difference corresponds to a time interval between two time points. The carrier phase difference further corresponds to an identity of at least one positioning signal, an identity of the terminal device and an identity of at least one positioning node.

For example, when the carrier phase difference is obtained by measuring the same positioning signal by the positioning node at different time points, the carrier phase difference corresponds to an identity of a positioning signal. When the carrier phase difference is obtained by measuring different positioning signals by the positioning node at different time points, the carrier phase difference corresponds to identities of at least two positioning signals.

For example, the carrier phase difference corresponds to a timestamp of the third time point and a timestamp of the fourth time point; or the carrier phase difference corresponds to a time interval from the third time point to the fourth time point.

For example, a plurality of carrier phase differences of one positioning signal may be measured by the positioning node. For example, the positioning node may measure a first positioning signal at T1 and T2 to obtain a third carrier phase difference and measure the first positioning signal at T3 and T4 to obtain a fourth carrier phase difference. T1 and T3 may be the same, and T2 is different from T4; or T1 is different from T3, and T2 and T4 are the same; or T1 is different from T3, T2 is different from T4, and T2 and T3 may be the same or not.

For example, a plurality of carrier phase differences of two different positioning signals may be measured by the positioning node. For example, the positioning node may measure the first positioning signal at T1 and a second positioning signal at T2 to obtain a fifth carrier phase difference, and measure a third positioning signal at T3 and a fourth positioning signal at T4 to obtain a sixth carrier phase difference. T1 is different from T2, T3 is different from T4, T1 and T3 may be the same or not, and T2 and T4 may be the same or not. The first positioning signal and the second positioning signal may be sent by the same terminal device or sent by different terminal devices.

For example, a plurality of positioning signals sent by the terminal device may be measured by the positioning node so as to obtain at least one carrier phase difference corresponding to each of the plurality of positioning signals. For example, the positioning node may measure the first positioning signal to obtain the third carrier phase difference and measure the second positioning signal to obtain the fourth carrier phase difference.

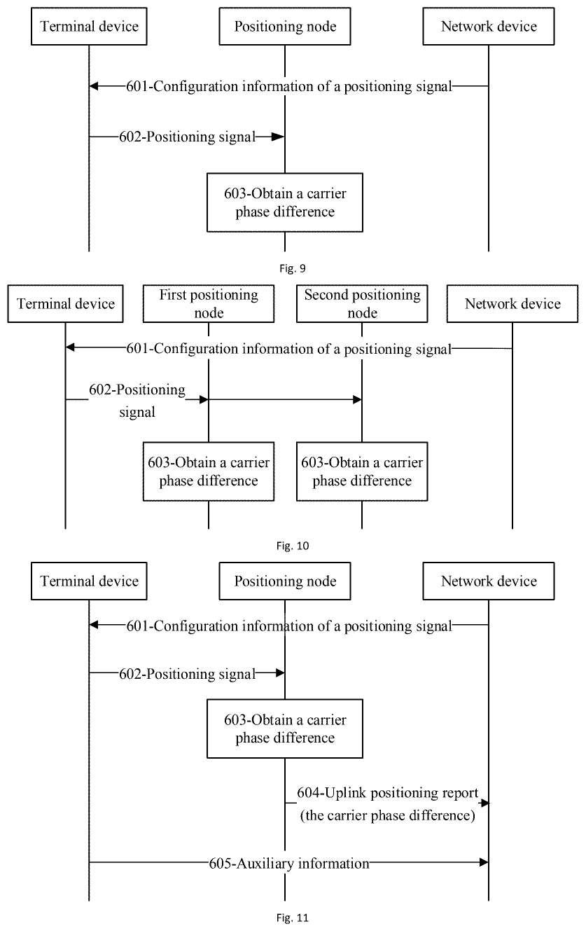

For example, a positioning signal sent by the terminal device may be measured simultaneously by a plurality of positioning nodes so as to obtain at least one carrier phase difference corresponding to each positioning node. For example, in step 602 shown in FIG. 10, the positioning signal sent by the terminal device may be received by a first positioning node and a second positioning node respectively. The third carrier phase difference is obtained by measuring the positioning signal by the first positioning node at t1 and t2, and the fourth carrier phase difference is obtained by measuring the positioning signal by the second positioning node at t3 and t4. t1 may be the same as t3 and t4 or not, t2 may be the same as t3 and t4 or not, t1 is different from t2, and t3 is different from t4.

For example, certainly, different positioning signals sent by the terminal device may also be measured by the plurality of positioning nodes respectively. A positioning node corresponding to a certain positioning signal may be specified in the configuration information of the positioning signal, and a specified positioning signal may be sent to this positioning node by the terminal device. For example, the first positioning signal sent by the terminal device is received by the first positioning node and measured to obtain the third carrier phase difference; and the second positioning signal sent by the terminal device is received by the second positioning node and measured to obtain the fourth carrier phase difference.

In step 603: the carrier phase difference is obtained by the positioning node.

The carrier phase difference is a measurement result of the positioning node. The carrier phase difference is a measurement result obtained by measuring the positioning signal by the positioning node at two time points. For example, the positioning node performs measurement at the third time point to obtain a third carrier phase and performs measurement at the fourth time point to obtain a fourth carrier phase, and the carrier phase difference is obtained by calculating a difference between the third carrier phase and the fourth carrier phase. Alternatively, the carrier phase difference is obtained by measuring a phase variation value of the positioning signal by the positioning node from the third time point to the fourth time point.

In an example, at least one obtained carrier phase difference may be reported to the network device by the positioning node.

To sum up, according to the method provided by the present example, the same positioning signal sent by the terminal device is measured by the positioning node in a plurality of time positions to obtain the carrier phase difference, and the position of the terminal device is solved based on the carrier phase difference. The terminal device may be positioned accurately by the method, so that the positioning accuracy reaches a centimeter level.

An example of reporting an uplink positioning report by the positioning node in the uplink positioning scene is given.

Please refer to FIG. 11, which shows a flowchart of a positioning method provided by an example of the disclosure. The method may be applied to a terminal device, a TRP (positioning node) and a network device in the communication system shown in FIG. 1. The network device may be an access network device or a core network device. Based on the example shown in FIG. 9, the method further includes step 604 and step 605.

In step 601: configuration information of a positioning signal sent by the network device is received by the terminal device.

For example, the configuration information indicates to send the positioning signal. Alternatively, the configuration information indicates to send three positioning signals respectively to three positioning nodes.

In step 602: a positioning signal sent by the terminal device is received by the positioning node.

For example, the positioning signals sent by the terminal device are received respectively by a first positioning node, a second positioning node and a third positioning node, and carrier phase differences are obtained by measuring the received positioning signals respectively. One positioning node may measure one or more positioning signals, for example, measuring one positioning signal to obtain a carrier phase difference corresponding to this positioning signal, or measuring two positioning signals to obtain carrier phase differences corresponding to the two positioning signals. The positioning signals measured by the different positioning nodes may be the same or not.

In step 603: the carrier phase difference is obtained by the positioning node.

For example, a first positioning signal is measured by the first positioning node at a moment 1 and a moment 2 to obtain a first carrier phase difference and at a moment 3 and a moment 4 to obtain a second carrier phase difference. Related information of the first carrier phase difference is recorded, for example, including at least one of the following: the first carrier phase difference, a timestamp of the moment 1, a timestamp of the moment 2, a time interval from the moment 1 to the moment 2, an identity of the first positioning node or an identity of the first positioning signal. Related information of the second carrier phase difference is recorded, for example, including at least one of the following: the second carrier phase difference, a timestamp of the moment 3, a timestamp of the moment 4, a time interval from the moment 3 to the moment 4, an identity of the first positioning node or an identity of the first positioning signal.

A second positioning signal is measured by the second positioning node within a first time interval to obtain a third carrier phase difference and within a second time interval to obtain a fourth carrier phase difference. Related information of the third carrier phase difference is recorded, for example, including at least one of the following: the third carrier phase difference, a timestamp of start time of the first time interval, a timestamp of end time of the first time interval, the first time interval, an identity of the second positioning node or an identity of the second positioning signal. Related information of the fourth carrier phase difference is recorded, for example, including at least one of the following: the fourth carrier phase difference, a timestamp of start time of the second time interval, a timestamp of end time of the second time interval, the second time interval, an identity of the second positioning node or an identity of the second positioning signal.

A third positioning signal is measured by the third positioning node at the moment 1 and the moment 2 to obtain a fifth carrier phase difference and at the moment 3 and the moment 4 to obtain a sixth carrier phase difference. Related information of the fifth carrier phase difference is recorded, for example, including at least one of the following: the fifth carrier phase difference, the timestamp of the moment 1, the timestamp of the moment 2, the time interval from the moment 1 to the moment 2, an identity of the third positioning node or an identity of the third positioning signal. Related information of the sixth carrier phase difference is recorded, for example, including at least one of the following: the sixth carrier phase difference, the timestamp of the moment 3, the timestamp of the moment 4, the time interval from the moment 3 to the moment 4, the identity of the third positioning node or the identity of the third positioning signal.

Alternatively, taking the first positioning node as an example (it is the same with other positioning nodes): the first positioning node measures the first positioning signal at the moment 1 and the second positioning signal at the moment 2 to obtain the first carrier phase difference, and measures the third positioning signal at the moment 3 and a fourth positioning signal at the moment 4 to obtain the second carrier phase difference. Related information of the first carrier phase difference is recorded, for example, including at least one of the following: the first carrier phase difference, the timestamp of the moment 1, the timestamp of the moment 2, the time interval from the moment 1 to the moment 2, the identity of the first positioning node, the identity of the first positioning signal, the identity of the second positioning signal or an identity of a first terminal device. Related information of the second carrier phase difference is recorded, for example, including at least one of the following: the second carrier phase difference, the timestamp of the moment 3, the timestamp of the moment 4, the time interval from the moment 3 to the moment 4, the identity of the first positioning node, the identity of the third positioning signal, an identity of the fourth positioning signal or an identity of a second terminal device. The first positioning signal and the second positioning signal are positioning signals sent by the same terminal device (for example, the first terminal device), and the third positioning signal and the fourth positioning signal are positioning signals sent by the same terminal device (for example, the second terminal device). The first terminal device and the second terminal device may be the same or not.

In step 604: an uplink positioning report is sent to the network device by the positioning node, where the uplink positioning report includes the carrier phase difference.

The network device receives the uplink positioning report and calculates based on the uplink positioning report to obtain a position of the terminal device.

The uplink positioning report includes at least one of the following: the carrier phase difference, two timestamps corresponding to the carrier phase difference, the time interval between the two time points corresponding to the carrier phase difference, phase error group information corresponding to the carrier phase difference, a positioning node (an identity of the positioning node) corresponding to the carrier phase difference, a positioning signal identity (an identity of a positioning signal) corresponding to the carrier phase difference, a terminal device (an identity of the terminal device) corresponding to the carrier phase difference, an identity of a positioning signal set corresponding to the carrier phase difference or collineation path indication information corresponding to the carrier phase difference.

The phase error group information includes a phase error group ID or an error value or a time error group ID. The positioning signal identity corresponding to the carrier phase difference includes at least one positioning signal identity. The terminal device corresponding to the carrier phase difference includes at least one terminal device.

One carrier phase difference corresponds to two timestamps, two timestamps corresponding to different carrier phase differences of the different positioning signals may be the same or not, and two timestamps corresponding to different carrier phase differences of the same positioning signal may not be completely the same.

The collineation path indication information is used to indicate whether a path measurement result is a collineation path or indicate a probability of the collineation path.

A positioning report further includes at least one of the following: reference signal receiving power (RSRP), an angle of arrival (AoA), an angle of departure (AoD), time of arrival (ToA), a time difference of arrival (TDoA), round trip time (RTT) or a timing error group. The timing error group includes an Rx timing error group (REG) or a Tx Rx timing error group (TREG).

For example, a parameter in the positioning report may be based on a measurement result of a path, namely, different paths correspond to a group of parameters in the above positioning report respectively. Alternatively, the different paths may not be considered in the positioning report, namely, the different paths correspond to the same group of parameters in the above positioning report.

For example, the positioning node may report a positioning report of measurement this time to the network device when a time window for measuring the positioning signal is over, where at least one carrier phase difference is included in the positioning report. The positioning node may also report the positioning report to the network device after obtaining a carrier phase difference, where the positioning report includes a carrier phase difference and related information of the same.

In step 605: assistance information is sent to the network device by the terminal device.

The assistance information includes at least one of the following: a moving distance of the terminal device, a moving speed of the terminal device, phase error group information corresponding to the positioning signal, and timing error group information corresponding to the positioning signal.

In some examples, the assistance information may be divided into first assistance information and second assistance information. The first assistance information includes the moving distance of the terminal device and/or the moving speed of the terminal device. The second assistance information includes the phase error group information corresponding to the positioning signal and timing error group information corresponding to the positioning signal.

As the network device needs to use a moving distance of the terminal device in two time points corresponding to the carrier phase difference when calculating the position of the terminal device by using the carrier phase difference, the terminal device at least needs to report the first assistance information to the network device. In some examples, the second assistance information may also be reported to the network device by the terminal device. The first assistance information and the second assistance information may be reported in a message, or reported in different messages.

The assistance information is used to assist the network device in calculating the position of the terminal device. The network device receives the assistance information, receives the positioning report sent by the positioning node, and calculates the position of the terminal device based on the positioning report and the first assistance information. In some examples, the position of the terminal device may also be corrected by the network device based on the second assistance information.

For the second assistance information, the second assistance information includes phase error group information and/or timing error group information corresponding to each positioning signal on each carrier frequency, the phase error group information and/or the timing error group information includes the phase error group ID and/or the timing error group ID, or the phase error group information and/or the timing error group information includes a phase error value and/or a timing error value.

Time for reporting the second assistance information by the terminal device is not limited, and the terminal device may report the second assistance information before step 602 or report the second assistance information after step 602.

Two reporting manners for the first assistance information are provided.

Manner 1: the first assistance information is sent to the network device directly by the terminal device after the terminal device sends the positioning signal The first assistance information includes at least one of the following: during sending the positioning signal by the terminal device: a moving distance, a moving trajectory (a timestamp is marked on each position point on the trajectory), a moving speed corresponding to at least one time point, a moving speed corresponding to at least one point on the moving trajectory, a moving speed corresponding to at least one interval on the moving trajectory, a moving distance of at least one time interval, and a moving speed of at least one time interval. Namely, a moving process during reporting the positioning signal may be reported by the terminal device as completely and finely as possible, so that the network device can obtain a moving distance/moving speed of the terminal device in two time points corresponding to each carrier phase difference corresponding to the positioning signal according to parameters in the moving process.

In the manner 1, reporting the first assistance information by the terminal device may be performed in any time after step 602, which has no absolute precedence relationship with step 603 and step 604.

Manner 2: the first assistance information may be reported by the terminal device based on indication information of the network device.

Two timestamps/a time interval corresponding to each carrier phase difference in an uplink positioning report are/is obtained by the network device after the uplink positioning report sent by the positioning node is received by the network device; and indication information is sent to the terminal device, where the indication information is used to indicate: the two timestamps/time interval corresponding to each carrier phase difference in the uplink positioning report. The terminal device receives the indication information sent by the network device and sends the first assistance information to the network device according to the timestamps/time interval indicated in the indication information, and the moving distance/moving speed of the terminal device between the two timestamps/within the time interval corresponding to the carrier phase difference are/is included in the first assistance information.

For example, the manner 1 and the manner 2 may be performed alternatively or synchronously. For example, the first assistance information is reported by the terminal device after the terminal device sends the positioning signal. The network device sends the indication information to the terminal device after the network device determines that the first assistance information sent by the terminal device is not applicable. The first assistance information is reported again by the terminal device according to the indication information.

To sum up, according to the method provided by the present example, the assistance information sent by the terminal device is received by the network device, where the assistance information includes the moving distance/moving speed of the terminal device; and the position of the terminal device is positioned by the network device based on the assistance information and the carrier phase difference in the positioning report. The assistance information may also include the phase error group information or the timing error group information, information in the positioning report may also be corrected by the network device based on the assistance information so as to obtain a more accurate measurement result, thus the position of the terminal device is solved accurately, the terminal device may be positioned accurately, and the positioning accuracy reaches a centimeter level.

It needs to be noted that those skilled in the art may combine any step in any example to implement a new example, which is not repeated.

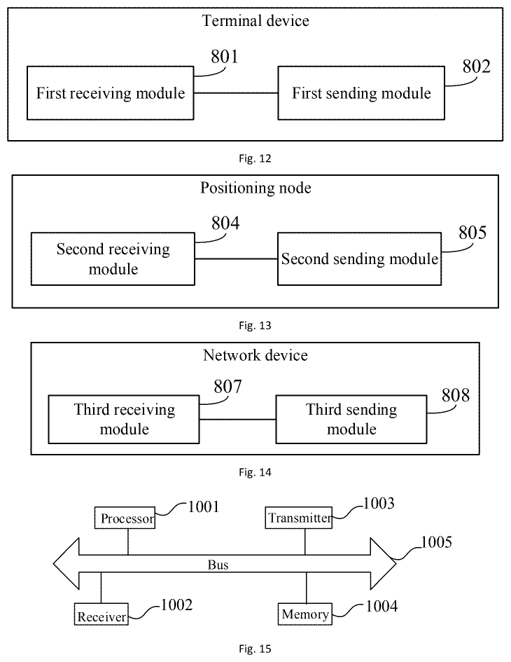

FIG. 12 shows a structural block diagram of a positioning apparatus provided by an example of the disclosure. The apparatus may be implemented as a terminal device, or a part in the terminal device. The apparatus includes a first receiving module 801.

The first receiving module 801, configured to receive configuration information of a positioning signal sent by a network device, where the positioning signal is configured to obtain a carrier phase difference based on carrier phases at different time points.

In an example, the carrier phase difference includes: a difference value between carrier phases of the positioning signal at two time points.

In an example, the carrier phase difference includes the number of whole cycles and a decimal part of an incomplete cycle of the carrier phase difference.

In an example, the positioning signal includes a downlink positioning signal, and the apparatus further includes:
the first receiving module 801, configured to obtain a first carrier phase by receiving, in a first time position, a positioning signal sent by a positioning node; and
the first receiving module 801, configured to obtain a second carrier phase by receiving, in a second time position, the positioning signal sent by the positioning node, where the carrier phase difference includes a difference value between the first carrier phase and the second carrier phase.

In an example, the positioning signal includes a downlink positioning signal.

The configuration information of the positioning signal includes at least one of the following: a cycle, a slotoffset, the number of repetitions in a single cycle, a time interval between two repetitions, the number of occupied symbols, a silent mode, a comb-shaped structure (comb-size), a position of a start symbol, a sub-carrier space, quasi-colocation (QCL) information, the number of measured samples, a carrier frequency, a bandwidth or a position of a starting physical resource block (PRB).

In an example, the configuration information of the positioning signal further includes: a positioning signal set or a positioning node corresponding to the positioning signal.

In an example, the positioning signal includes a downlink positioning signal, and the apparatus further includes a first sending module 802.

The first sending module 802, configured to send a downlink positioning report to the network device, where the downlink positioning report includes the carrier phase difference.

In an example, the downlink positioning report includes at least one of the following: the carrier phase difference, two timestamps corresponding to the carrier phase difference, a time interval between two time points corresponding to the carrier phase difference, a moving distance of the terminal device within a time interval between the two timestamps or between the two time points, a moving speed of the terminal device within the time interval between the two timestamps or between the two time, phase error group information corresponding to the carrier phase difference, a positioning node corresponding to the carrier phase difference, a positioning signal identity corresponding to the carrier phase difference, an identity of a positioning signal set corresponding to the carrier phase difference or collineation path indication information corresponding to the carrier phase difference.

In an example, the downlink positioning report further includes at least one of the following: reference signal receiving power (RSRP), an angle of arrival, an angle of departure, time of arrival, a time difference of arrival, round trip time or a timing error group.

In an example, the positioning signal includes an uplink positioning signal, and the apparatus further includes:
the first sending module 802, configured to send the positioning signal based on the configuration information of the positioning signal.

In an example, the configuration information of the positioning signal includes at least one of the following: a cycle, a slotoffset, the number of occupied symbols, a comb-shaped structure (comb-size), a position of a start symbol, a sub-carrier space, quasi-colocation (QCL) information, a carrier frequency, a bandwidth, a position of a starting physical resource block (PRB), power control parameters P0 and alpha, or a path loss reference.

In an example, the apparatus further includes:
the first sending module 802, configured to send assistance information to the network device, where the assistance information includes at least one of the following: a moving distance of the terminal device, a moving speed of the terminal device, phase error group information corresponding to the positioning signal or timing error group information corresponding to the positioning signal.

In an example, the positioning signal includes: a positioning reference signal (PRS) or a sounding reference signal (SRS).

FIG. 13 shows a structural block diagram of a positioning apparatus provided by an example of the disclosure. The apparatus may be implemented as a positioning node, or a part in the positioning node. The apparatus includes a second receiving module 804.

The second receiving module 804, configured to receive a positioning signal sent by a terminal device, where the positioning signal is configured to obtain a carrier phase difference based on carrier phases at different time points.

In an example, the carrier phase difference includes: a difference value between carrier phases of the positioning signal at two time points.

In an example, the carrier phase difference includes the number of whole cycles and a decimal part of an incomplete cycle of the carrier phase difference.

In an example, the apparatus further includes:
the second receiving module 804, configured to obtain a third carrier phase by receiving, at third time point, the positioning signal sent by the terminal device; and
the second receiving module 804, configured to obtain a fourth carrier phase by receiving, at fourth time point, the positioning signal sent by the terminal device, where the carrier phase difference includes a difference value between the third carrier phase and the fourth carrier phase.

In an example, the apparatus further includes a second sending module 805.

The second sending module 805, configured to send an uplink positioning report to the network device, where the uplink positioning report includes the carrier phase difference.

In an example, the uplink positioning report includes at least one of the following: the carrier phase difference, two timestamps corresponding to the carrier phase difference, a time interval between two time points corresponding to the carrier phase difference, phase error group information corresponding to the carrier phase difference, a positioning node corresponding to the carrier phase difference, a terminal device corresponding to the carrier phase difference, a positioning signal identity corresponding to the carrier phase difference, an identity of a positioning signal set corresponding to the carrier phase difference or collineation path indication information corresponding to the carrier phase difference.

In an example, the uplink positioning report further includes at least one of the following: reference signal receiving power (RSRP), an angle of arrival, an angle of departure, time of arrival, a time difference of arrival, round trip time or a timing error group.

In an example, the positioning signal includes a sounding reference signal (SRS).

FIG. 14 shows a structural block diagram of a positioning apparatus provided by an example of the disclosure. The apparatus may be implemented as a network device, or a part in the network device. The apparatus includes:
a third sending module 808, configured to send configuration information of a positioning signal to a terminal device, where the positioning signal is configured to obtain a carrier phase difference based on carrier phases at different time points.

In an example, the carrier phase difference includes: a difference value between carrier phases of the positioning signal at two time points.

In an example, the carrier phase difference includes the number of whole cycles and a decimal part of an incomplete cycle of the carrier phase difference.

In an example, the positioning signal includes a downlink positioning signal, and the carrier phase difference includes: a difference value between a first carrier phase of the positioning signal received by the terminal device in a first time position and a second carrier phase of the positioning signal received by the terminal device in a second time position;
or the positioning signal includes an uplink positioning signal, and the carrier phase difference includes: a difference value between a third carrier phase of the positioning signal received by a positioning node at third time point and a fourth carrier phase of the positioning signal received by the positioning node at fourth time point.

In an example, the positioning signal includes the downlink positioning signal.

The configuration information of the positioning signal includes at least one of the following: a cycle, a slotoffset, the number of repetitions in a single cycle, a time interval between two repetitions, the number of occupied symbols, a silent mode, a comb structure (comb-size), a position of a start symbol, a sub-carrier space, quasi-colocation (QCL) information, the number of measured samples, a carrier frequency, a bandwidth or a position of a starting physical resource block (PRB).

In an example, the configuration information of the positioning signal further includes: a positioning signal set or a positioning node corresponding to the positioning signal.

In an example, the positioning signal includes the downlink positioning signal, and the apparatus further includes:
a third receiving module 807, configured to receive a downlink positioning report sent by the terminal device, where the downlink positioning report includes the carrier phase difference.

In an example, the downlink positioning report includes at least one of the following: the carrier phase difference, two timestamps corresponding to the carrier phase difference, a time interval between two time points corresponding to the carrier phase difference, a moving distance of the terminal device within a time interval between the two timestamps or between the two time points, a moving speed of the terminal device within the time interval between the two timestamps or between the two time points, phase error group information corresponding to the carrier phase difference, a positioning node corresponding to the carrier phase difference, a positioning signal identity corresponding to the carrier phase difference, an identity of a positioning signal set corresponding to the carrier phase difference or collineation path indication information corresponding to the carrier phase difference.

In an example, the downlink positioning report further includes at least one of the following: reference signal receiving power (RSRP), an angle of arrival, an angle of departure, time of arrival, a time difference of arrival, round trip time or a timing error group.

In an example, the positioning signal includes the uplink positioning signal.

The configuration information of the positioning signal includes at least one of the following: a cycle, a slotoffset, the number of occupied symbols, a comb-shaped structure (comb-size), a position of a start symbol, a sub-carrier space, quasi-colocation (QCL) information, a carrier frequency, a bandwidth, a position of a starting physical resource block (PRB), power control parameters P0 and alpha, or a path loss reference.

In an example, the positioning signal includes the uplink positioning signal, and the apparatus further includes:
the third receiving module 807, configured to receive an uplink positioning report sent by the positioning node, where the uplink positioning report includes the carrier phase difference.

In an example, the uplink positioning report includes at least one of the following: the carrier phase difference, two timestamps corresponding to the carrier phase difference, a time interval between two time points corresponding to the carrier phase difference, phase error group information corresponding to the carrier phase difference, a positioning node corresponding to the carrier phase difference, a terminal device corresponding to the carrier phase difference, a positioning signal identity corresponding to the carrier phase difference, an identity of a positioning signal set corresponding to the carrier phase difference or collineation path indication information corresponding to the carrier phase difference.

In an example, the uplink positioning report further includes at least one of the following: reference signal receiving power (RSRP), an angle of arrival, an angle of departure, time of arrival, a time difference of arrival, round trip time or a timing error group.

In an example, the apparatus further includes:
the third receiving module 807, configured to receive assistance information sent by the terminal device, where the assistance information includes at least one of the following: a moving distance of the terminal device, a moving speed of the terminal device, phase error group information corresponding to the positioning signal, and timing error group information corresponding to the positioning signal.

In an example, the positioning signal includes: a positioning reference signal (PRS) or a sounding reference signal (SRS).

FIG. 15 shows a schematic structural diagram of a communication device (a terminal device or a network device) provided by an example of the disclosure. The communication device includes: a processor 1001, a receiver 1002, a transmitter 1003, a memory 1004 and a bus 1005.

The processor 1001 includes one or more than one processing core, and the processor 1001 performs various functional applications and information processing by running a software program and modules.

The receiver 1002 and the transmitter 1003 may be implemented as a communication component, and the communication component may be a communication chip.

The memory 1004 is connected with the processor 1001 through the bus 1005.

The memory 1004 may be configured to store at least one instruction, and the processor 1001 is configured to perform the at least one instruction so as to implement all steps in the above method example.

Besides, the memory 1004 may be implemented by any type of volatile or non-volatile storage device or their combination, and the volatile or non-volatile storage device includes but is not limited to: a magnetic disk or an optical disk, an electrically-erasable programmable read-only memory (EEPROM), an erasable programmable read-only memory (EPROM), a static random access memory (SRAM), a read-only memory (ROM), a magnetic memory, a flash memory and a programmable read-only memory (PROM).

When the communication device is implemented as the terminal device, the processor and a transceiver in the communication device involved in the example of the disclosure may perform steps performed by the terminal device in any method shown in FIGS. 2 to 4 and FIGS. 6 to 11, which is not repeated here.

In a possible implementation, when the communication device is implemented as the terminal device,
the transceiver is configured to receive configuration information of a positioning signal sent by the network device, where the positioning signal is configured to obtain a carrier phase difference based on carrier phases at different time points.

When the communication device is implemented as the network device, the processor and the transceiver in the communication device involved in the example of the disclosure may perform steps performed by the positioning node in any method shown in FIGS. 2 to 4 and FIGS. 6 to 11, which is not repeated here.

In a possible implementation, when the communication device is implemented as the network device,
the transceiver is configured to receive a positioning signal sent by the terminal device, where the positioning signal is configured to obtain a carrier phase difference based on carrier phases at different time points.

When the communication device is implemented as the network device, the processor and the transceiver in the communication device involved in the example of the disclosure may perform steps performed by the network device in any method shown in FIGS. 2 to 4 and FIGS. 6 to 11, which is not repeated here.

In a possible implementation, when the communication device is implemented as the network device,
the transceiver is configured to send configuration information of a positioning signal to the terminal device, where the positioning signal is configured to obtain a carrier phase difference based on carrier phases at different time points.

In an example, a non-transitory computer-readable storage medium is further provided, storing at least one instruction, at least one segment of program, a code set or an instruction set, where the at least one instruction, the at least one segment of program, the code set or the instruction set is loaded and performed by a processor so as to implement the positioning method performed by a communication device provided by each of the above method examples.

In an example, a chip is further provided, including a programmable logic circuit and/or a program instruction, where the chip is configured to implement, when running on a computer device, the positioning method in the above aspect.

In an example, a computer program product is further provided, where the computer program product, when running on a processor of a computer device, causes the computer device to perform the positioning method in the above aspect.

The technical solutions provided by the examples of the disclosure at least include the following beneficial effects.

The carrier phase difference is obtained by measurement at different time points for the same positioning signal, and the terminal device is positioned based on the carrier phase difference. The positioning method based on the carrier phase difference is introduced into a cellular network, a positioning signal for carrier phase difference positioning is configured for the terminal device, and the terminal device is caused to receive or send the positioning signal based on the configuration information. The carrier phase difference is measured by the positioning node or the terminal device, the carrier phase difference is reported to the network device, a position of the terminal device is solved by the network device based on the carrier phase difference, so as to accurately position the terminal device, and thus the positioning accuracy reaches a centimeter level.

Those ordinarily skilled in the art can understand that implementing all or part of steps in the above example may be completed by hardware, or completed by commanding related hardware through a program, the program may be stored in a computer-readable storage medium, and the above mentioned storage medium may be a read-only memory, a magnetic disk, an optical disk or the like.

The foregoing descriptions are merely optional examples of the disclosure, but are not intended to limit the disclosure. Any modification, equivalent replacement, or improvement, etc. made within the spirit and principle of the disclosure falls within the protection scope of the disclosure.

1. A positioning method, performed by a terminal device, comprising:
receiving configuration information of a positioning signal sent by a network device, wherein the positioning signal is configured to obtain a carrier phase difference based on carrier phases at different time points.

2. The positioning method according to claim 1, wherein the carrier phase difference comprises: a difference value between carrier phases of the positioning signal at two time points; or
the carrier phase difference comprises: a difference value between carrier phases of the positioning signal at two time points, and a number of whole cycles and a decimal part of an incomplete cycle of the carrier phase difference.

3. (canceled)

4. The positioning method according to claim 2, wherein the positioning signal comprises a downlink positioning signal, and the positioning method further comprises:
obtaining a first carrier phase by receiving, in a first time position, a positioning signal sent by a positioning node; and
obtaining a second carrier phase by receiving, in a second time position, the positioning signal sent by the positioning node, wherein the carrier phase difference comprises a difference value between the first carrier phase and the second carrier phase.

5. The positioning method according to claim 1, wherein the positioning signal comprises a downlink positioning signal:
the configuration information of the positioning signal comprises at least one of the following: a cycle, a slotoffset, a number of repetitions in a single cycle, a time interval between two repetitions, a number of occupied symbols, a silent mode, a comb structure size (comb-size), a position of a start symbol, a sub-carrier space, quasi-colocation (QCL) information, a number of measured samples, a carrier frequency, a bandwidth or a position of a starting physical resource block (PRB); and
wherein the configuration information of the positioning signal further comprises: a positioning signal set or a positioning node corresponding to the positioning signal.

6. (canceled)

7. The positioning method according to claim 1, wherein the positioning signal comprises a downlink positioning signal, and the positioning method further comprises:
sending a downlink positioning report to the network device,
wherein the downlink positioning report comprises at least one of the following: the carrier phase difference, two timestamps corresponding to the carrier phase difference, a time interval between two time points corresponding to the carrier phase difference, a moving distance of the terminal device within a time interval between the two timestamps or between the two time points, a moving speed of the terminal device within the time interval between the two timestamps or between the two time points, phase error group information corresponding to the carrier phase difference, a positioning node corresponding to the carrier phase difference, a positioning signal identity corresponding to the carrier phase difference, an identity of a positioning signal set corresponding to the carrier phase difference or collineation path indication information corresponding to the carrier phase difference.

8-9. (canceled)

10. The positioning method according to claim 2, wherein the positioning signal comprises an uplink positioning signal, and the positioning method further comprises:
sending the positioning signal based on the configuration information of the positioning signal, wherein the configuration information of the positioning signal comprises at least one of the following: a cycle, a slotoffset, a number of occupied symbols, a comb-shaped structure (comb-size), a position of a start symbol, a sub-carrier space, quasi-colocation (OCL) information, a carrier frequency, a bandwidth, a position of a starting physical resource block (PRB), power control parameters P0 and alpha, or a path loss reference.

11-13. (canceled)

14. A positioning method, performed by a positioning node, comprising:
receiving a positioning signal sent by a terminal device, wherein the positioning signal is configured to obtain a carrier phase difference based on carrier phases at different time points.

15. The positioning method according to claim 14, wherein the carrier phase difference comprises: a difference value between carrier phases of the positioning signal at two time points; or
the carrier phase difference comprises: a difference value between carrier phases of the positioning signal at two time points, and a number of whole cycles and a decimal part of an incomplete cycle of the carrier phase difference.

16. (canceled)

17. The positioning method according to claim 15, wherein receiving the positioning signal sent by the terminal device comprises:
obtaining a third carrier phase by receiving, at third time point, the positioning signal sent by the terminal device; and
obtaining a fourth carrier phase by receiving, at fourth time point, the positioning signal sent by the terminal device, wherein the carrier phase difference comprises a difference value between the third carrier phase and the fourth carrier phase.

18. The positioning method according to claim 14, further comprising:
sending an uplink positioning report to a network device,
wherein the uplink positioning report comprises at least one of the following: the carrier phase difference, two timestamps corresponding to the carrier phase difference, a time interval between two time points corresponding to the carrier phase difference, phase error group information corresponding to the carrier phase difference, a positioning node corresponding to the carrier phase difference, a terminal device corresponding to the carrier phase difference, a positioning signal identity corresponding to the carrier phase difference, an identity of a positioning signal set corresponding to the carrier phase difference or collineation path indication information corresponding to the carrier phase difference.

19-21. (canceled)

22. A positioning method, performed by a network device, comprising:
sending configuration information of a positioning signal to a terminal device, wherein the positioning signal is configured to obtain a carrier phase difference based on carrier phases at different time points.

23. The positioning method according to claim 22, wherein the carrier phase difference comprises: a difference value between carrier phases of the positioning signal at two time points; or
the carrier phase difference comprises: a difference value between carrier phases of the positioning signal at two time points, and a number of whole cycles and a decimal part of an incomplete cycle of the carrier phase difference.

24. (canceled)

25. The positioning method according to claim 23, wherein the positioning signal comprises a downlink positioning signal, and the carrier phase difference comprises: a difference value between a first carrier phase of the positioning signal received by the terminal device in a first time position and a second carrier phase of the positioning signal received by the terminal device in a second time position;
or
the positioning signal comprises an uplink positioning signal, and the carrier phase difference comprises: a difference value between a third carrier phase of the positioning signal received by a positioning node at third time and a fourth carrier phase of the positioning signal received by the positioning node at fourth time.

26. The positioning method according to claim 22, wherein the positioning signal comprises a downlink positioning signal; and
the configuration information of the positioning signal comprises at least one of the following: a cycle, a slotoffset, a number of repetitions in a single cycle, a time interval between two repetitions, a number of occupied symbols, a silent mode, a comb structure (comb-size), a position of a start symbol, a sub-carrier space, quasi-colocation (QCL) information, a number of measured samples, a carrier frequency, a bandwidth or a position of a starting physical resource block (PRB); and
wherein the configuration information of the positioning signal further comprises: a positioning signal set or a positioning node corresponding to the positioning signal.

27. (canceled)

28. The positioning method according to claim 22, wherein the positioning signal comprises a downlink positioning signal, and the positioning method further comprises:
receiving a downlink positioning report sent by the terminal device,
wherein the downlink positioning report comprises at least one of the following: the carrier phase difference, two timestamps corresponding to the carrier phase difference, a time interval between two time points corresponding to the carrier phase difference, a moving distance of the terminal device within a time interval between the two timestamps or between the two time points, a moving speed of the terminal device within the time interval between the two timestamps or between the two time points, phase error group information corresponding to the carrier phase difference, a positioning node corresponding to the carrier phase difference, a positioning signal identity corresponding to the carrier phase difference, an identity of a positioning signal set corresponding to the carrier phase difference or collineation path indication information corresponding to the carrier phase difference.

29-30. (canceled)

31. The positioning method according to claim 22, wherein the positioning signal comprises an uplink positioning signal; and
the configuration information of the positioning signal comprises at least one of the following: a cycle, a slotoffset, a number of occupied symbols, a comb structure (comb-size), a position of a start symbol, a sub-carrier space, quasi-colocation (QCL) information, a carrier frequency, a bandwidth, a position of a starting physical resource block (PRB), a power control parameter P0 and alpha or a path loss reference.

32. The positioning method according to claim 22, wherein the positioning signal comprises an uplink positioning signal, and the positioning method further comprises:
receiving an uplink positioning report sent by a positioning node,
wherein the uplink positioning report comprises at least one of the following: the carrier phase difference, two timestamps corresponding to the carrier phase difference, a time interval between two time points corresponding to the carrier phase difference, phase error group information corresponding to the carrier phase difference, the positioning node corresponding to the carrier phase difference, the terminal device corresponding to the carrier phase difference, a positioning signal identity corresponding to the carrier phase difference, an identity of a positioning signal set corresponding to the carrier phase difference or collineation path indication information corresponding to the carrier phase difference.

33-39. (canceled)

40. A terminal device, comprising: a processor and a transceiver connected with the processor; wherein
the transceiver is configured to implement the positioning method according to claim 1.

41. A network device, comprising: a processor and a transceiver connected with the processor; wherein
the transceiver is configured to implement the positioning method according to claim 14.

42. A network device, comprising: a processor and a transceiver connected with the processor; wherein
the transceiver is configured to implement the positioning method according to claim 22.

43-45. (canceled)
